(19) United States
(12) Patent Application Publication
(10) Pub. No.: US 2002/0191831 A1
(43) Pub. Date: Dec. 19, 2002

(54) System and process for analyzing surface defects

(75) Inventors: Giuseppe Spoto, S. Giovanni La Punta (IT); Marco Branciforte, Catania (IT); Francesco Doddo, Milazzo (IT); Luigi Occhipinti, Ragusa (IT)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics S.r.l., Agrate Brianza (IT)

(21) Appl. No.: 10/132,876

(22) Filed: Apr. 25, 2002

(30) Foreign Application Priority Data
May 2, 2001 (EP) 01830289.3

(51) Int. Cl. G06K 9/00

(52) U.S. Cl. 382/141; 382/154; 382/257; 382/278; 382/108

(57) ABSTRACT

Three-dimensional analysis of surface defects and microdefects of an object is performed by correlating two images of the surface of the object based upon a stereoscopic view thereof. Analyzing surface defects may be implemented by integrating, in a single monolithic component made using VLSI CMOS technology, an optical sensor with a cellular neural network. The optical sensor includes a matrix of cells configured as analog processors.

### FIELD OF THE INVENTION

The present invention relates to the field of integrated circuits, and in particular, to a system and process for analyzing surface defects of an object.

### BACKGROUND OF THE INVENTION

Surface defects in materials are frequently the cause of sudden, and almost always unforeseeable structural changes which involves a drastic reduction in the intrinsic safety of each system, and consequently, the safety of the users. The importance that quality control currently assumes in any production involves the need to implement new analysis systems that can yield efficient results in a short time. This is to be done without being too costly, which inevitably increases the final cost of the system.

In applications in which safety and quality play a fundamental role, it is necessary to determine beforehand the presence of defects in the materials. This determination depends upon the capacity of analysis systems to perform their functions. The most widespread techniques of analysis fall within the class of non-destructive tests (NDTs), i.e., testing that can be carried out during the operation of systems without impairing their integrity.

At present, numerous techniques are used for non-destructive testing of systems. The most widely used techniques use penetrants, magnetoscopy tests, ultrasound analysis, fluoroscopy, analysis using induced currents, and acoustic testing. Many of these techniques achieve an acceptable degree of reliability with regards to the identification of surface defects. However, every one of these techniques suffers from certain limitations. In fact, the use of the above techniques requires adequate equipment, which is frequently costly, and in some cases, of unwieldy dimensions, and can be used only by specialized personnel. In addition, the time necessary for identifying defects is often very long and has a direct bearing upon the economic aspects involved in testing. An example is represented by the materials used in aeronautical applications.

Added to the above limitations is the fact that frequently the execution of a test requires the disassembly of the piece that is to undergo analysis. A consequence of this is that it is impossible to carry out the control in the actual physical site where the piece is located during use. This affects the economic aspects of the test conducted. At present there do not exist systems that are able to carry out non-destructive tests rapidly by analyzing images of the object undergoing testing, detecting the presence of surface imperfections and characterizing them if they are present.

There exist on the market a number of systems using optics at a microscopic level that emulate the stereoscopic technique by using two optical devices with parallel axes. However, such systems do not yield quantitative information on the dimensions of the object being analyzed, and in particular, do not yield three-dimensional numerical information.

Other systems using optical investigation carry out a surface scanning of the object to yield a profile thereof for a single section. These systems are, however, very costly and are not portable. At present, operation of the systems that apply the technique of stereoscopic vision is based upon the identification of the conjugate points of the two images. However, the identification of these points represents the major difficulty in the application of the technique considered.

### SUMMARY OF THE INVENTION

In view of the foregoing background, an object of the present invention is to provide a system and corresponding process for performing a three-dimensional analysis on the surface of an object.

According to the present invention, the above purpose is achieved thanks to a system having the characteristics called for specifically in the ensuing claims. The invention also regards the corresponding process.

### BRIEF DESCRIPTION OF THE DRAWINGS

The invention will now be described, purely by way of non-limiting examples, with reference to the attached drawings, in which:

FIG. 1 shows two images of a scene acquired from two different observation points in accordance with the present invention;

FIG. 2 is a basic diagram of a system for a three-dimensional analysis of the surface of an object in accordance with the present invention;

FIG. 3 is a block diagram of a cellular neural network (CNN) in accordance with the present invention;

FIGS. 4, 5 and 6 are flowcharts illustrating in detail operation of a system in accordance with the present invention;

FIGS. 7a and 7b show a sequence of images taken by system in accordance with the present invention;

FIG. 8 shows images of a surface defect obtained in accordance with the present invention;

FIG. 9 shows further images of a surface defect obtained in accordance with the present invention; and

FIG. 10 shows a depth map of a surface defect detected in accordance with the present invention.

### DETAILED DESCRIPTION OF THE PREFERRED EMBODIMENTS

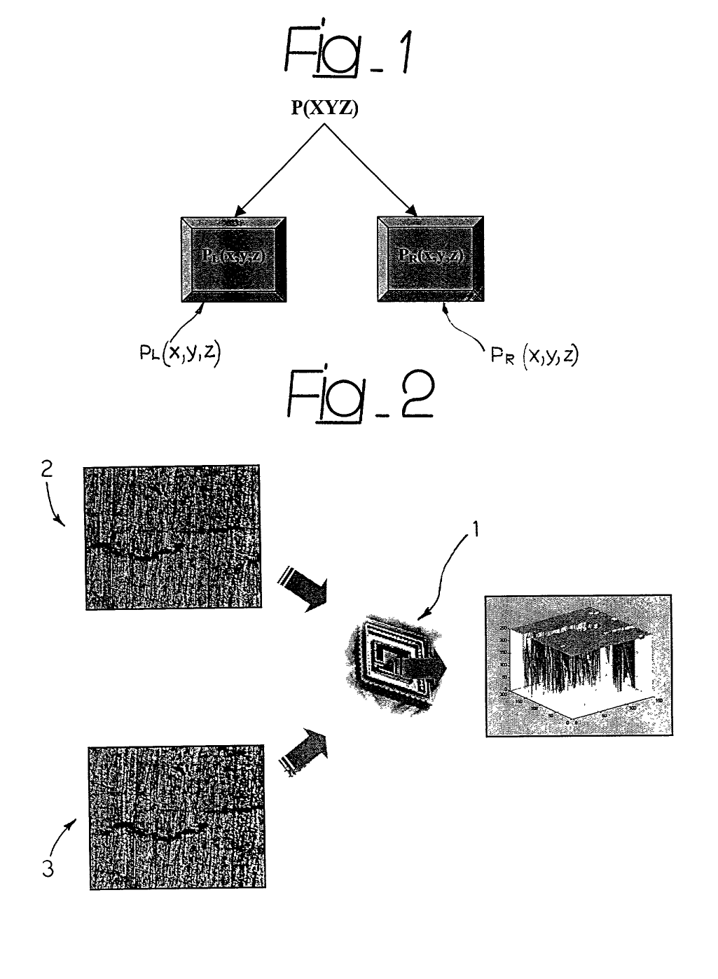

To facilitate a more immediate understanding of the characteristics of the present invention, characteristics of the stereoscopy technique will initially be described. Referring to FIG. 1, suppose that two initial images P_{L}(x,y,z) and P_{R}(x,y,z,) of a scene are available. These two images are acquired from two different observation points.

From these two images, i.e., the left-hand image P_{L} and the right-hand image P_{R}, it is possible to extrapolate information on the relative distance between the objects that make up the scene. In fact, if a point in space is acquired from different positions, it may be projected onto the planes of the two images in positions that are different with respect to a reference system that is fixed with respect to the plane of the two images themselves.

Through correlation analysis there are identified, on the planes of the images, the relative positions of the two points corresponding to the single point in space of which they are the projections. Once the relative coordinates of the two points are known and the relative difference of abscissa between them has been calculated, (referred to as disparity) the depth of the single point in space with respect to the plane of the images is derived by applying the following formula:

$$Z = \frac{B \cdot f}{{x}_{left} - {x}_{right}}$$

Z is the depth factor, B is the relative distance between the two points of acquisition of the left-hand image and of the right-hand image, and f is the focal distance characteristic of the system of lenses used for the acquisition. The variables x_{left} and x_{right} are the coordinates of the point acquired in the left-hand image and in the right-hand image, respectively.

The formula given above applies, for instance, to the case in which detection is carried out using an optical sensor, i.e., a telecamera, which is translated so as to be displaced from one pixel to another, remaining on the same row. For this reason, the coordinate present in the formula is only the x coordinate, and the formula takes into account the translation.

The main difficulty in applying this technique is in identifying the points correlated in the two images. To determine these points, it is possible to use different techniques that take into account the levels of brightness of the pixels of the two images and their respective neighborhoods.

An example of the correlation technique between conjugate points is described by the following formula:

$${C}_{12} ( τ ) = \frac{1}{k} {\sum }_{{u}_{1} = - N}^{+ N} {\sum }_{{v}_{1} = - P}^{+ P} ( {I}_{1} ( {u}_{1} + {u}_{0} , {v}_{1} + {v}_{0} ) - \overline{{I}_{1} ( {u}_{0} , {v}_{0} )} ) \cdot ( {I}_{2} ( {u}_{1} + {u}_{0} + τ , {v}_{1} + {v}_{0} ) - \overline{{I}_{2} ( {u}_{0} + τ , {v}_{0} )} ) ;$$

C₁₂ is the value of correlation between the pixels of image 1 (the left-hand image, for example) and the pixels of image 2 (the right-hand image), I₁, and I₂ represent the intensity of brightness of the pixels belonging to the two images (the neighborhood considered for each pixel is equal to N×P pixels), and k is a factor that depends upon the standard deviation of the levels of brightness of the neighborhood of each individual pixel.

At the maximum value of correlation, the coordinates of the conjugate points are determined, and hence the disparity between the points necessary for calculating the depth. The algorithmic approaches described present a non-indifferent computational burden. Consequently, to use them according to traditional schemes, very powerful calculation systems are required. This often entails long analysis times.

The system and corresponding process according to the present invention makes it possible to overcome the above described drawbacks due to the high calculation speed of cellular neural networks (CNNs) processing signals, and in particular, images. For a general illustration of the characteristics of a cellular neural network, reference is directed to U.S. Pat. No. 5,140,670.

The architecture according to the invention uses a cellular neural network for identifying and characterizing the defects through techniques of stereoscopic vision. These techniques can thus be introduced also into modern production systems, without adversely affecting performance in terms of production rates and costs.

As is known also from U.S. Pat. No. 5,864,836, a cellular neural network is a system that includes elementary cells that operate continuously in time. These cells are arranged with state variables connected to the neighboring cells in one-, two- or three-dimensional space. This system can be considered a programmable parallel processor capable, in particular, of being used in a wide range of applications in the image-processing field. In addition, the system may be rendered self-adaptive with the addition of appropriate circuits.

A type of processing carried out by a given cellular neural network depends upon the extent (magnitude and sign) of the interactions that exist between the cells. Consequently, the system is programmable in so far as it is possible to vary, during the operating phase, the values of the interactions. The implementation of two-dimensional cellular neural networks draws advantage from the planar topology of the system itself for the reason that these networks can be implemented using electronic and opto-electronic technology.

In a particularly advantageous way, the architecture of a cellular neural network comprises a matrix of cells that are locally interconnected through synaptic connections. This matrix thus has a spatial distribution which, by its very nature, is substantially correlated to the matrix of the processed images. In particular, this system is based upon stereoscopic vision.

The system and process according to the invention processes the signals of a cellular neural network, thus avoiding digitization of the image. This enables, with all other factors being equal, a considerable increase in the processing speed with respect to the sensors that require digitization of the image signal. In particular, the system and process according to the invention makes it possible to create the system for acquisition and processing of the corresponding signals in the framework of a single chip.

Cellular neural networks are generally based upon conventional VLSI techniques, and in particular, based upon CMOS technology. A system according to the invention can be easily built in a system-on-chip (SOC) configuration, whereby the entire system for acquisition and processing of the images is integrated on a single chip, for example, using VLSI CMOS technologies.

In this connection, reference may be made to the article by Rodriguez-Vasquez et al., “Review of CMOS Implementations of the CNN Universal Machine-Type Visual Microprocessors”, published in the Proceedings of ISCAS 2000 (IEEE Int. Symposium on Circuits and Systems), Geneva, May 28-31, 2000. An approach that uses an optical input integrated in the device is the one described by Espejo et al. (IEEE Journal of Solid-State Circuits, SSC-29 (8), pp. 895-905; 1994).

In the currently preferred embodiment, the invention relates to a system that comprises an optical microsensor 1, built using CMOS technology, and capable of carrying out real-time analysis of the input information. The optical interface of the system is made up of a matrix or array of sensors with inputs on rows and columns governed by an internal logic control. The invention thus enables a system to be monolithically integrated on a semiconductor substrate for automatic three-dimensional analysis of images of the surfaces of objects.

The system is based upon microarrays of the type comprising optical sensors arranged in matrix form for the acquisition of the images, and an architecture for parallel analog processing of high computational efficiency. This processing is based upon the use of a cellular neural network (CNN). The processing is basically of an analog type and is performed in a spatially distributed way over the entire development of the microarray matrix.

According to the invention, once certain parameters have been fixed, the dynamic system is allowed to evolve from the initial state to the stable state (final state), and the resulting image is stored in a local memory. When the image has been completely acquired, it is stored internally as a voltage value (pixel by pixel).

The general criteria that enables configuration of the sensor 1 as an optical sensor that is able to produce the image are known in the art. This general criteria does not require a detailed description herein because these elements are not essential for understanding the invention.

The level of luminosity or brightness of each pixel of the image is processed by an element of the grid which, as a whole, makes up the acquisition system. The sensor 1 is preferably built using CMOS technology so as to comprise an optical chip that includes a matrix of photosensors with inputs on rows and columns governed by an internal logic control.

The sensor 1 comprises an analog part containing n*m cells, each cell with an optical sensor of its own for a respective pixel. The sensor is thus able to generate, in a known way, a first image signal 2 and a second image signal 3 organized according to pixels, which represent, respectively, a first surface image and a second surface image for locating and identifying possible defects. In particular, as will be better appreciated from what follows, the two images may correspond to two images detected from the same observation point of a moving object.

To carry out real-time processing of the input information, each pixel is locally connected to a process unit or cell which implements a state equation of the type appearing below:

$$C \frac{ⅆ {v}_{xij} ( t )}{ⅆ t} = - \frac{1}{{R}_{x}} {v}_{xij} ( t ) + {\sum }_{C ( k , l ) ∈ {N}_{r} ( i , j )} A ( i , j ; k , l ) \cdot {v}_{ykl} ( t ) + {\sum }_{C ( k , l ) ∈ {N}_{r} ( i , j )} B ( i , j ; k , l ) \cdot {v}_{ukl} ( t ) + {I}_{bias}$$

The variable vₓᵢⱼ and vᵤᵢⱼ are respectively the initial state and the input voltage of the individual cell, indicated by Cᵢⱼ. Nᵣ(i,j) is the neighborhood of unit radius of the individual cell, and A, B and I_{bias} are parameters the values of which influence the behavior of each individual cell in the processing of the acquired image.

In particular, A and B are matrices of dimensions 3×3, and I_{bias} is a single value. The equation appearing above refers to the general paradigm, as described in U.S. Pat. No. 5,140,670, of cellular neural networks introduced by Chua and Young. This represents the state of the art as far as the technology regarding image processing is concerned.

In particular, in the architecture diagram of FIG. 3, the reference number 11 designates the array (typically a matrix array) of analog cells comprising the optical sensors Qᵢⱼ. The cells are interconnected locally to the adjacent cells through a series of programmable parameters of weight and bias, i.e., the factors A, B and I_{bias} mentioned previously, which form the parameters of configuration of the neural network.

The reference number 12 designates an internal analog memory for temporary storage of the intermediate values of the cells. The reference number 13 designates digital registers for storing the programming and configuration parameters that are to be transmitted to the array 11 after prior conversion into an analog format performed by a digital-to-analog converter 14.

The reference number 15 designates a program digital memory (configured, for example, as a flash, EPROM or SRAM memory with external memory interface), while the reference number 16 designates a control logic that drives all the elements of the architecture. The control logic 16 may also function as a decoder during the operation of reading of the processing results generated in the array 11 of analog cells. The reference number 17 designates the input/output circuits (both of an analog type and of a digital type) designed to provide the interfacing external the cellular neural network, and the programming of the chip.

The interaction between the blocks 11 to 17 (which are readily known to one skilled in the art) are indicated by the arrows, i.e., single-headed or double-headed arrows, as illustrated in FIG. 3. Basically, each processing step is performed by fixing known values of the parameters referred to above and letting the system evolve in a dynamic way from an initial state to a stable final condition, and then storing the resultant image in the local memory.

As readily known (see, for example, the CNN Software Library—Templates and Algorithms—Version 7.3, ANL, Budapest, August 1999), in the case of the so-called universal CNN machines, operating procedures are implementable both on single images and on double images. Once the image has been completely acquired (with an acquisition time that depends upon the resolution of the chip and upon the corresponding technology), it is stored internally as a set of voltage analog values (pixel by pixel), which are then to be processed directly on the chip with the proposed architecture.

The architecture of the system considered for determining the three-dimensional characteristics of the surface of objects comprises a matrix of analog processors (cells) comprising the optical acquisition sensors. Each cell is connected to all the cells surrounding it, and interacts with them through appropriate programmable parameter values and threshold values, i.e., the so-called templates.

The system further includes an analog internal memory for temporary storage of the values assumed by the cells (images), digital registers for storage of the programmable parameters and of the digital-to-analog converters (DACs), and a programmable digital memory (such as an EPROM, a flash, and an SRAM). There are also logic controllers of peripherals, which act as decoders of information coming from processes carried out by the cells of the circuit on the images considered. Input/output (I/O) circuits interface the chip and enable its external programming.

Each process includes a series of operations executed on the basis of the values of the initial parameters entered. The system evolves dynamically from an initial state up to a condition of stability, the characteristic values of which corresponding to the images acquired are stored in local memories. As a result of the use of on-chip analog memories, it is possible to acquire two different images (a right-hand one and a left-hand one) in a very short time. This is also according to the speed of movement of the object for detecting the presence of surface defects.

An example is represented by the images of an object on a conveyor belt moving at a constant speed. Each input image is stored internally, and each pixel is associated with an analog voltage value attributed to each cell of the grid. Processing of the signals takes place according to the architecture described.

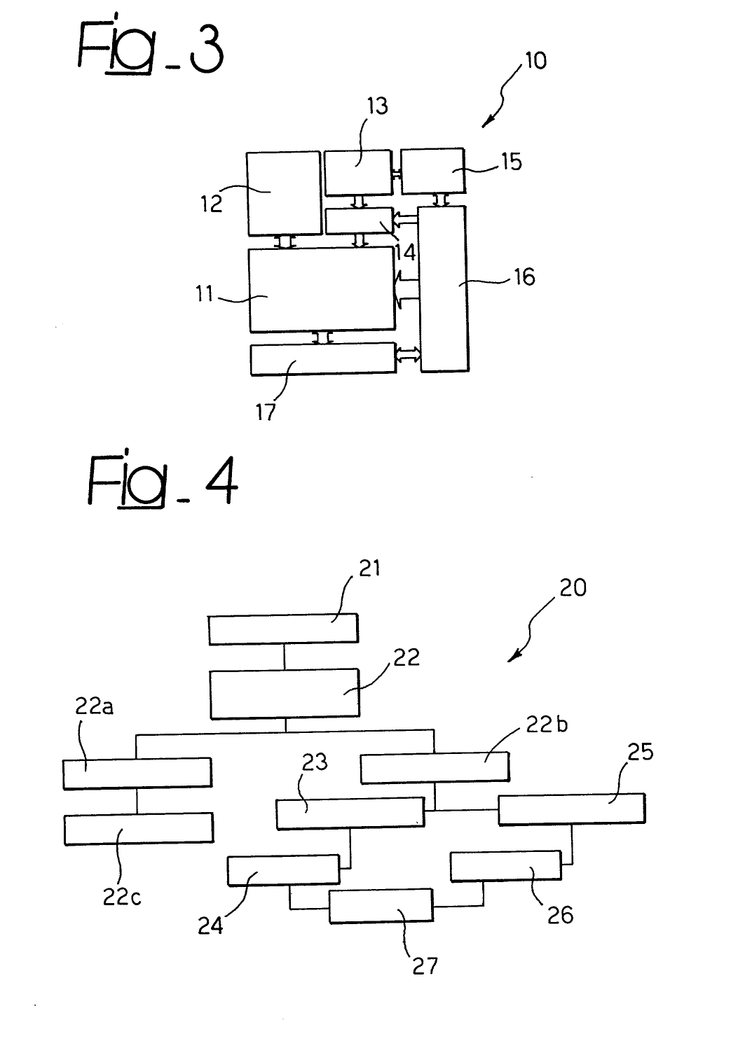

In the preferred embodiment of the invention, the proposed system implements the methodology of automatic analysis represented schematically in FIG. 4. This methodology, designated as a whole by reference 20, comprises the following operations: acquisition 21 of the stereoscopic images of the object; application 22 of a first defect-detection algorithm; output 22c if the defect-detection algorithm has given a negative answer 22a; application 23 of the same defect-detection algorithm if it has given a positive answer 22b to identifying the surface characteristics of the defect 24; application of a further algorithm 25 (stereo algorithm) designed to determine the information on the depth of the defect; and presentation of a final report 27 summarizing the dimensional characteristics of the defect.

Identification of the defect is performed through a known technique of characterization of the static image to determine the presence of a surface defect. This is done whether the right-hand or the left-hand image is used. For this purpose, it is sufficient to carry out straight forward operations of thresholding, contour detection, noise removal, hollow filling and calculation of the sum of the pixels that remain active. If the number of pixels remaining active is sufficiently high, it may be inferred that there is a defect present.

The defect-detection algorithm, designated as a whole by 30 in FIG. 5, includes in the application to the initial images, designated by 31a and 31b, of a series of templates designed to extract the defect and isolate it from the rest of the image. By way of a non-limiting example, templates are used in an illustrated application of the algorithm itself, in conditions of non-controlled illumination, for the purpose of identifying and characterizing a surface defect like the one caused by cyclic stresses on a mechanical member.

In particular, the templates appearing below refer to the implementation of the coefficients A and B of the cellular neural network in the form of 3×3 matrices.

a) Edge-Detection Template (32a and 32b). This operation enables extraction of the contours of the defect.

$$A = [ \begin{matrix}0 & 0 & 0 \\ 0 & 2 & 0 \\ 0 & 0 & 0\end{matrix} ] B = [ \begin{matrix}- 1 & - 1 & - 1 \\ - 1 & 8 & - 1 \\ - 1 & - 1 & - 1\end{matrix} ] {I}_{bias} = - 0.5$$

b) Erosion Template (33a and 33b). This is used for eroding the objects of larger dimensions, eliminating a part of the noise present.

$$A = [ \begin{matrix}0 & 0 & 0 \\ 0 & 0 & 0 \\ 0 & 0 & 0\end{matrix} ] B = [ \begin{matrix}0 & 1 & 0 \\ 0 & 1 & 1 \\ 0 & 0 & 0\end{matrix} ] {I}_{bias} = - 2$$

c) Small-Object-Remover Template or Small Killer (34a and 34b). This removes the objects of smaller dimensions, eliminating the noise present in an isolated form.

$$A = [ \begin{matrix}1 & 1 & 1 \\ 1 & 2 & 1 \\ 1 & 1 & 1\end{matrix} ] B = [ \begin{matrix}0 & 0 & 0 \\ 0 & 0 & 0 \\ 0 & 0 & 0\end{matrix} ] {I}_{bias} = 0$$

d) Dilation Template (35a and 35b). This performs a reconstruction of the image, restoring the defect to its original dimensions:

$$A = [ \begin{matrix}0 & 0 & 0 \\ 0 & 0 & 0 \\ 0 & 0 & 0\end{matrix} ] B = [ \begin{matrix}0 & 0 & 0 \\ 1 & 1 & 0 \\ 0 & 1 & 0\end{matrix} ] {I}_{bias} = 2$$

In this way, the characteristics of the defect are determined (resulting images, designated by 36a and 36b).

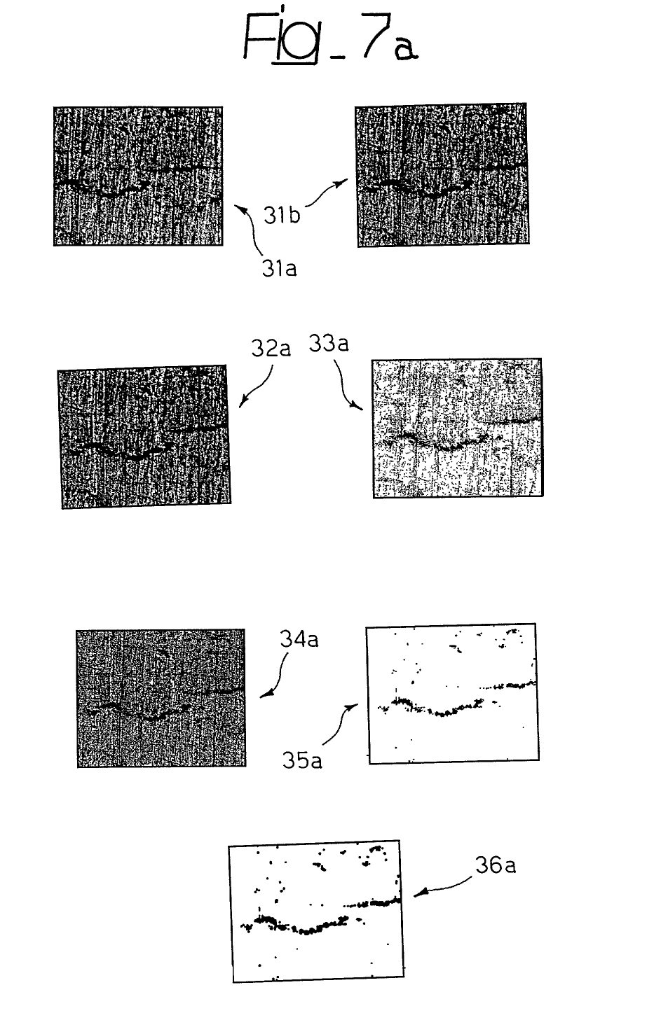

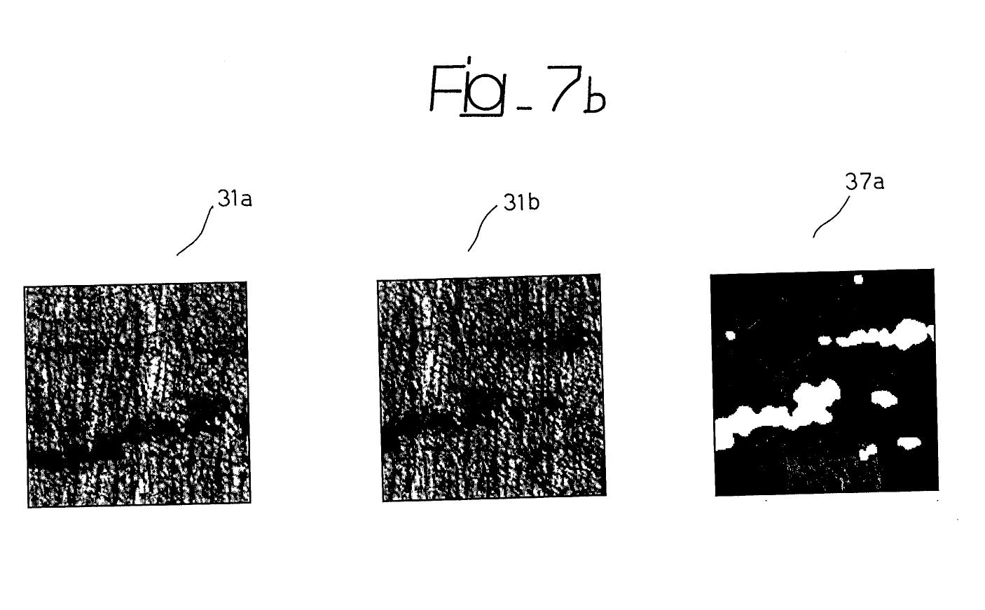

FIG. 7a shows, in addition to the first image 31a and the second image 31b, the results of the application of the templates 32a, 33a, 34a and 35a described previously, to the first image of the defect acquired with a system of lenses with 50× magnification for arriving at a resulting image designated by 36a. FIG. 7b shows the mask of the first image obtained by applying the defect-detection algorithm. Application of the defect-detection algorithm enables isolation of the defect from the rest of the image and determination of its surface extension.

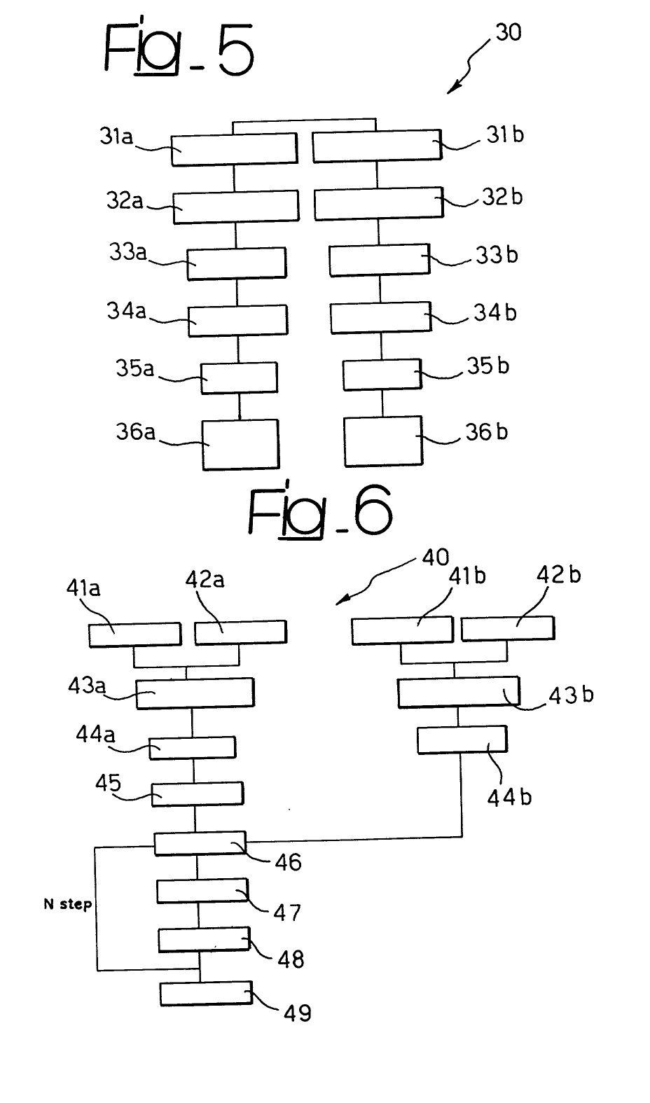

The next step includes determining a map of the depth of the defect. To do so, it is necessary to identify, for each pixel of the first image, the corresponding pixel of the second image, calculate the disparity between the two correlated points, and calculate the depth of the defect by applying the corresponding formula. Determination of the correlated points is made by applying the stereo algorithm illustrated in FIG. 6, with reference to its application to a portion of the defect analyzed previously.

Given the initial images 41a and 41b and the ones determined by applying the defect-detection algorithm, i.e., the ones designated by 42a and 42b. The latter two images are superimposed on the former images, using them as masks. In this way, masked images 43a and 43b are obtained, in which the disturbance present in the acquired images has been eliminated without modifying the shades of gray where the defect is present. This is done so as not to alter the levels of depth of the defect in the two starting images.

Application of the masks to the original images 41a and 41b also prevents determination of correlated points external to the defect itself, which may generate errors in the calculation of the disparity. Since the starting images are acquired without any control over the source of illumination, there is always present noise, which could generate errors in the determination of the corresponding points.

Isolation of the defect with its own levels of brightness is performed by applying repeatedly a template, known as a Figdel template. Application of this template to the masked images 43a and 43b enables cancellation of all the elements of the scene, leaving the masked elements unaltered, i.e., the ones located where the defect is. In the example given, only one part of the image on which the depth map has been determined is considered. Using the same approach adopted previously, the template in question can be defined, as specified below.

Figdel Template (44a and 44b). This cancels out the objects of the scene, leaving unaltered the ones on which the mask is applied.

$$A = [ \begin{matrix}0 & 0 & 0 \\ 0 & 1 & 0 \\ 0 & 0 & 0\end{matrix} ] B = [ \begin{matrix}- 1 & - 1 & - 1 \\ - 1 & 1 & - 1 \\ - 1 & - 1 & - 1\end{matrix} ] {I}_{bias} = - 8$$

By applying the template in question repeatedly to each of the two masked images, the images shown in FIG. 8 are obtained. These are free from elements of disturbance but present shades of gray that are unaltered with respect to the initial images where the defect is located.

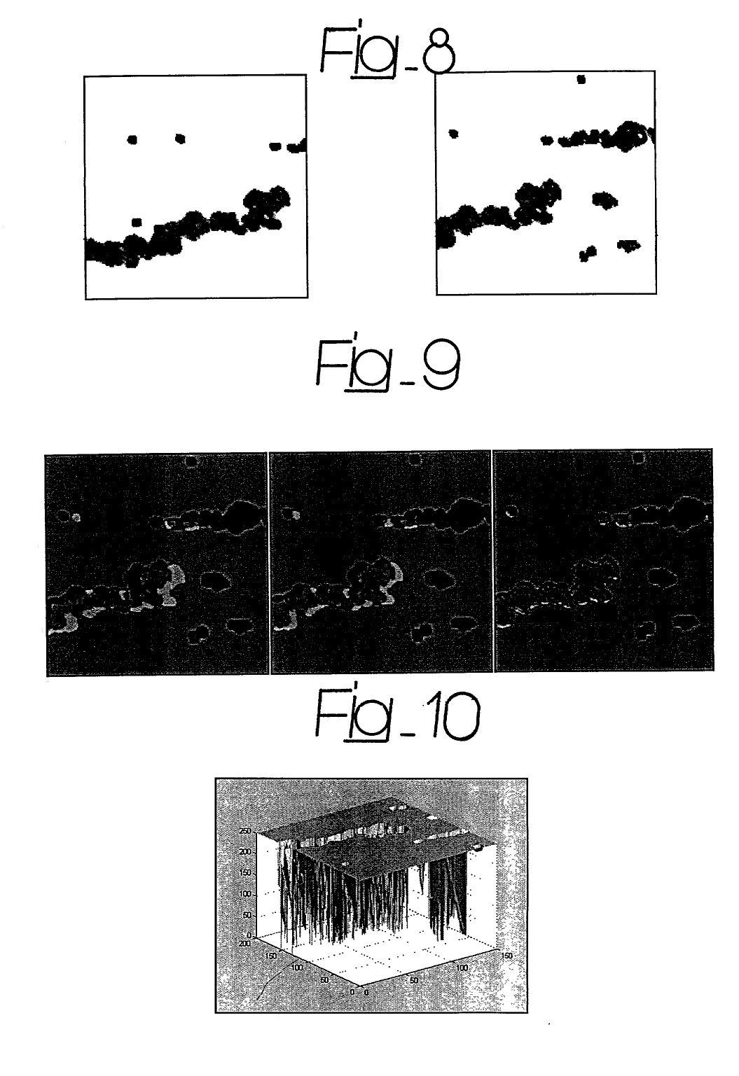

Determination of the correlated points is made by considering a series of images that originate from translating (step 45) the left-hand image until it is superimposed on the right-hand image (superposition of some portions of the images is not possible on account of the absence in one image of some pixels that are present in the other image), and by calculating the difference (step 46), pixel by pixel, between the right-hand image and each of the images obtained by translating the left-hand image. In this way, a series of difference images are obtained (see FIG. 9), and a minimum value is determined (step 48) among the series of images. Yet another template 47 may be applied. This template is an averaging function, known as an Average Template, and is defined below.

Average Template (47). This operation makes an average of the levels of brightness of the surrounding area or neighborhood, attributing the value thereof to the central pixel of the area, as follows:

$$A = [ \begin{matrix}0 & 1 & 0 \\ 1 & 2 & 1 \\ 0 & 1 & 0\end{matrix} ] B = [ \begin{matrix}0 & 0 & 0 \\ 0 & 0 & 0 \\ 0 & 0 & 0\end{matrix} ] {I}_{bias} = 1$$

The above are the corresponding pixels, and hence the pixels correlated between the two images. If the amount of the translation at the point corresponding to the minimum value found is known, the value of the disparity between the correlated pixels is accordingly determined.

By repeating the same process for each pixel of the defect, a complete map of the depth of the defect is determined (step 49). As an example of the application presented, a number of difference images are shown in FIG. 9, while FIG. 10 presents the depth map determined in an area corresponding to the deepest area of the defect.

The indications of the depth are given according to a scale factor. This must take into account both the focal distance for the system of lenses through which the images are acquired, and the relative translation of the two images. The method according to the present invention presents numerous advantages for performing non-destructive tests and quality-control tests, and moreover, affords a wide range of application possibilities.

The main advantages deriving from the use of the present invention are numerous. One of the advantages is the high speed of processing of the images. This is a characteristic of cellular neural networks, which makes it possible to obtain in real time the results of the processing. In fact, no analog-to-digital conversion (or vice-versa) is necessary of the values of each pixel of the image acquired at the output from the optical sensor with respect to the processing matrix operating in parallel, which executes the image-analysis algorithm of the micro-array.

In this way, it is possible to overcome the intrinsic limit of current techniques of analysis, which require long processing times. A further advantage is the possibility of operating just where the component being examined is used, provided that this is located in a position where it can be seen by the operator. It is also possible to re-program the system in a straightforward manner by using a few coefficients that define the templates of the cellular neural network. These coefficients correspond to the individual operations stored in the internal memory of the system, and in points corresponding to the values of the synaptic connections between adjacent cells.

The system can moreover be applied directly in the production environment to investigate the quality of mass-produced articles. The method described is very robust, however critical may be the aspects linked to the sources of illumination. The two images are in fact acquired simultaneously in the same lighting conditions.

One application of the present invention is quality control of objects undergoing fabrication/processing. In particular, the present invention is ideally suited to the implementation of systems capable of acquiring, with a certain frequency, images of an object that is being fed along a conveyor, such as a conveyor belt, or any other system of movement.

In the latter application, it is usually sufficient to acquire the images by a single optical sensor, which, exploiting the translation of the pieces and acquiring the images with a frequency that is linked to the translation of the pieces, makes the double image acquisition which is necessary for applying the stereoscopic technique.

In this connection, it may be further noted that none of the known systems makes use of an optical output and/or of the possible reconfigurability (control) by optical signals. With regards to programmability, it will moreover be noted that that the known systems that use programmability only furnish the possibility of implementing a discrete set of values for the weights of connections between the cells. Programming is always via electrical signals, and normally each cell should be programmed (controlled) in an identical way to all the others.

Of course, without prejudice to the principle of the invention, the details of implementation and the embodiments may vary widely with respect to what is described and illustrated herein, without departing from the scope of the present invention as defined in the annexed claims.

That which is claimed is:

1. A system for the analysis of surface defects in objects, said system being associatable to an image sensor (1) that is able to generate at least one first image signal (2) and one second image signal (3) for the surfaces of said objects, characterized in that it comprises a circuit (10) for processing said at least one first image signal and said at least one second image signal by means of correlation of the said image signals, and in that said processing circuit is configured as a cellular neural network (CNN).

2. The system according to claim 1, characterized in that it comprises said image sensor (1) integrated with said cellular neural network (CNN).

3. The system according to claim 1 or claim 2, characterized in that it comprises said image sensor (1) and said processing circuit (10) integrated on a single chip.

4. The system according to any one of claims 1 to 3, characterized in that it comprises said image sensor (1) and said processing circuit (10) configured to acquire the input information and carry out analysis thereof in real time.

5. The system according to any one of claims 1 to 4, characterized in that said image sensor (1) and/or said processing circuit (10) are built using VLSI CMOS technologies.

6. The system according to claim 1, characterized in that said cellular neural network comprises a matrix of cells (Cᵢⱼ), each cell of said matrix being locally interconnected to all the cells surrounding it and interacting with them by means of programmable parameter values and threshold values.

7. The system according to claim 1, characterized in that said processing circuit (10) comprises:
at least one analog internal memory (12) for temporary storage of the values assumed by said at least one first image signal and said at least one second image signal; and
digital registers (13) for storing the programmable parameters of the cellular neural network.

8. The system according to claim 7, characterized in that said processing circuit (10) further comprises:
programmable digital memories (15);
logic controllers (16) of peripherals, which are able to act as decoders of the information resulting from the processes carried out by the cells of the circuit on the images considered; and
input/output circuits (17) for interfacing the chip and enabling external programming thereof.

9. The system according to claim 7 or claim 8, characterized in that the characteristic values of the dynamic evolution of the system from an initial state to the condition of stability are stored in said at least one analog internal memory (12).

10. The system according to any one of the preceding claims, characterized in that said at least one first image signal (2) and said at least one second image signal (3) are organized according to pixels, and in that the system is configured to store said at least one first image signal (2) and said at least one second image signal (3), associating to each pixel thereof at least one voltage analog value attributed to a respective cell of the cellular neural network.

11. A process for analysis of surface defects of objects, characterized in that it comprises the operations of:
acquiring at least one first image (2) and said at least one second image (3) of the surface of an object, said at least one first image and said at least one second image identifying a stereoscopic vision of said surface; and
performing (10) a correlation of said at least one first image and said at least one second image, the result of said correlation being indicative of the characteristics of depth of said surface, said operation of correlation being performed by means of a cellular neural network.

12. The process according to claim 11, characterized in that it comprises the operation of acquiring said images point by point, and in that said correlation is made point by point.

13. The process according to either claim 11 or claim 12, characterized in that it comprises the operation of applying, to said at least one first image and said at least one second image, at least one between:
a first algorithm (30) for identification and surface characterization of a possible defect; and
a second algorithm (40) for determination of the depth map of said defect, using the visual technique of stereoscopy.

14. The process according to claim 13, characterized in that said first algorithm for identifying the defect comprises the operations of:
thresholding of said images;
contour detection of said images;
noise removal;
hollow filling; and
calculation of the sum of the pixels that remain active.

15. The process according to either claim 13 or claim 14, characterized in that said first algorithm for identifying the surface defect performs a characterization of the static image on the basis of two images, a right-hand image (P_{R}) and a left-hand image (P_{L}).

16. The process according to claim 11 or claim 13, characterized in that it comprises the operation of applying, to said first image (2) and said second image (3), a series of templates that are able to extract the defect and isolate it from the rest of the image.

17. The process according to claim 16, characterized in that said templates are chosen from among the group made up of:
a first template (Edge Detection—32a and 32b), which is able to extract the contours of the defect, returning an image in shades of gray or in color;
a second template (Erosion —33a and 33b), which is able to erode the objects of larger dimensions with the purpose of eliminating the noise;
a third template (Small-Object Remover template—“Small Killer”—34a and 34b), which is able to remove the objects of smaller dimensions with the purpose of eliminating any noise that is present in isolated form; and
a fourth template (Dilation —35a and 35b), which is able to perform a reconstruction of the image, restoring the defect to its original dimensions.

18. The process according to claim 13, characterized in that said second algorithm comprises the operations of:
superimposing the images (42a and 42b) obtained using said first algorithm on said first image (41a) and said second image (41b), using them as masks so as to obtain respective masked images (43a and 43b);
repeatedly applying to each of the two masked images (43a and 43b), which are free from elements of disturbance, a respective template (Figdel—44a and 44b), which are able to cancel out all the elements of the scene, leaving unaltered the masked ones that are located in an area corresponding to a possible defect;
translating (45) one between said first image and said second image until one of said images is superimposed on the other between said first image and said second image;
calculating the difference (46), pixel by pixel, between the other between said first image and each of the images obtained by translating said one between said first image and said second image, thus finding a series of images; and
determining (58) the pixels which, among the series of images found, present a minimum value and which represent the correlated pixels, and hence determine, by repeating this process for each pixel, the complete depth map of the defect.

19. The process according to claim 18, characterized in that it comprises the operation of performing an average (47) of the levels of brightness of the area surrounding each pixel, attributing the value thereof to the central pixel of the said area.

20. The process according to any one of claims 11 to 19, characterized in that, in said at least one first image (2) and said at least one second image (3), a reconstruction of correlated pixels is made, determining at least one between the complete depth maps of the defect and the three-dimensional image of said defect.

21. The process according to any one of claims 11 to 20, characterized in that it comprises the operation of acquiring said at least one first image (2) and said at least one second image (3) as images at successive points in time of a moving object.
